(19) United States
(12) Patent Application Publication
(10) Pub. No.: US 2025/0123664 A1
(43) Pub. Date: Apr. 17, 2025

(54) ELECTRONIC APPARATUS AND CONTROL METHOD

(71) Applicant: CANON KABUSHIKI KAISHA, Tokyo (JP)

(72) Inventor: YASUHITO KIGURE, Tokyo (JP)

(21) Appl. No.: 18/910,690

(22) Filed: Oct. 9, 2024

(30) Foreign Application Priority Data
Oct. 11, 2023 (JP) 2023-176110

(51) Int. Cl. G06F 1/26

(52) U.S. Cl. CPC G06F 1/263

(57) ABSTRACT

One or more embodiments of an electronic apparatus may include a connection unit to which a plurality of power supply apparatuses can be connected, a plurality of power receiving units that receive a power from the plurality of power supply apparatuses, a plurality of power source units that convert voltage values of the power supplied from the plurality of power supply apparatuses and supply the power to a plurality of load units, and a control unit that decides a voltage value and a current value for receiving the power from the plurality of power supply apparatuses based on a number of the plurality of power supply apparatuses and a power consumption of the plurality of load units, and that performs control to output the power received from the plurality of power supply apparatuses to any of the plurality of power source units.

### CROSS-REFERENCE TO RELATED APPLICATION(S)

This application claims the benefit of Japanese Patent Application No. 2023-176110, filed Oct. 11, 2023, which is hereby incorporated by reference herein in its entirety.

### BACKGROUND

### Field of the Disclosure

One or more features of the present disclosure relate to one or more embodiments or technique(s) for supplying power from a plurality of power supply apparatuses to a power receiving apparatus.

### Description of the Related Art

The universal serial bus (USB) power delivery (PD) standard is a standard that can supply power by connecting a power supply apparatus and a power receiving apparatus by a connector and a cable of the USB Type-C standard. In the USB PD standard, a power supply apparatus (source apparatus) and a power receiving apparatus (sink apparatus) perform communication for deciding power that can be supplied or received based on a power rule including a combination of a voltage value and a current value.

The power receiving apparatus includes a voltage conversion circuit that converts a voltage received from the power supply apparatus into an operable voltage of a load unit of the power receiving apparatus. In the voltage conversion circuit, the larger the difference between an input voltage and an output voltage is, the lower the conversion efficiency is and the larger the power loss is.

The higher the operable voltage of the load unit of the power receiving apparatus becomes, the higher the voltage received from the power supply apparatus becomes. Therefore, the power loss due to the voltage conversion becomes large, and for example, when the power supply apparatus is a mobile battery, the operable time of the power receiving apparatus becomes short.

Japanese Patent Laid-Open No. 2008-193816 describes a power receiving apparatus that requires power supply from a plurality of power supply apparatuses, and performs the following: monitoring whether each power supply apparatus can supply power, and starting a power supply when as many power supply apparatuses as the power receiving apparatus requires have become capable of supplying power.

Japanese Patent Laid-Open No. 2008-193816 needs to increase the number of power supply apparatuses in response to an increase in the power required by the power receiving apparatus.

### SUMMARY

One or more features of the present disclosure have been made in consideration of the aforementioned issues, and one or more features of the present disclosure realize techniques for reducing power loss due to voltage conversion in a power receiving apparatus.

In order to solve the aforementioned issues, one or more features of the present disclosure provide one or more embodiments of an electronic apparatus that may include or comprise: a connection unit to which a plurality of power supply apparatuses can be connected; a plurality of power receiving units that receive a power from the plurality of power supply apparatuses; a plurality of power source units that convert voltage values of power supplied from the plurality of power supply apparatuses and supply the power to a plurality of load units; and a control unit that decides a voltage value and a current value for receiving the power from the plurality of power supply apparatuses based on a number of the plurality of power supply apparatuses and a power consumption of the plurality of load units, and that performs control to output the power received from the plurality of power supply apparatuses to any of the plurality of power source units.

In order to solve the aforementioned issues, one or more features of the present disclosure provide one or more embodiments of a control method of an electronic apparatus that may include a connection unit to which a plurality of power supply apparatuses can be connected, a plurality of power receiving units that receive a power from the plurality of power supply apparatuses, and a plurality of power source units that convert voltage values of power supplied from the plurality of power supply apparatuses and supply the power to a plurality of load units, wherein the control method may include or comprise: deciding a voltage value and a current value for receiving the power from the plurality of power supply apparatuses based on a number of the plurality of power supply apparatuses and a power consumption of the plurality of load units, and performing control to output the power received from the plurality of power supply apparatuses to any of the plurality of power source units.

According to one or more features of the present disclosure, it is possible to reduce power loss due to voltage conversion in a power receiving apparatus.

According to other aspects of the present disclosure, one or more additional electronic apparatuses and/or power supply apparatuses and one or more methods are discussed herein. Further features of the present disclosure will become apparent from the following description of exemplary embodiments (with reference to the attached drawings).

### BRIEF DESCRIPTION OF THE DRAWINGS

FIG. 1 is a view illustrating a system configuration diagram according to a first embodiment according to one or more embodiments of the present disclosure.

FIG. 2 is a block diagram illustrating a configuration of an electronic apparatus according to one or more embodiments of the present disclosure.

FIG. 3 is a block diagram illustrating a configuration of a connection unit, a power source control unit, and a power source unit of the electronic apparatus according to one or more embodiments of the present disclosure.

FIG. 4 is a view illustrating a reference table used for control processing according to one or more embodiments of the present disclosure.

FIG. 5 is a flowchart exemplifying control processing according to one or more embodiments of the present disclosure.

FIG. 6 is a view illustrating a reference table used for control processing according to one or more embodiments of the present disclosure.

FIG. 7 is a block diagram illustrating a configuration of an electronic apparatus according to one or more embodiments of the present disclosure.

FIG. 8 is a block diagram illustrating a configuration of a connection unit, a power source control unit, and a power source unit of the electronic apparatus according to one or more embodiments of the present disclosure.

FIGS. 9A and 9B are flowcharts exemplifying control processing according to one or more embodiments of the present disclosure.

### DESCRIPTION OF THE EMBODIMENTS

Hereinafter, one or more embodiments and/or features of the present disclosure will be described in detail with reference to the attached drawings. Note, the following embodiments are not intended to limit the scope of the claimed features of the present disclosure. Multiple features are described in the embodiments, but limitation is not made to an embodiment that requires all such features, and one or more of such features may be combined as appropriate in one or more embodiments. Furthermore, in the attached drawings, the same reference numerals are given to the same or similar configurations, and redundant description thereof is omitted.

### Embodiment Examples

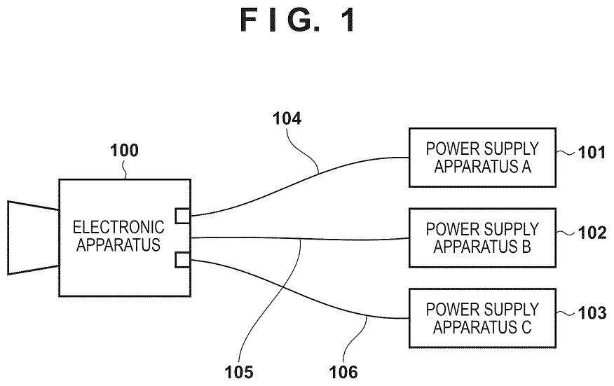

Hereinafter, one or more embodiment examples will be described with reference to FIGS. 1 to 5.

FIG. 1 is a view illustrating a system configuration according to one or more features of the present disclosure.

The present system embodiment of the present disclosure includes an electronic apparatus 100 and one or more power supply apparatuses A 101, B 102, and C 103 that can be connected to the electronic apparatus 100.

The electronic apparatus 100 is an image capturing device such as a digital video camera. The electronic apparatus 100 operates as a power receiving apparatus that can receive power from the power supply apparatus A 101, the power supply apparatus B 102, and the power supply apparatus C 103. The electronic apparatus 100 is operable by power received from at least any of the power supply apparatus A 101, the power supply apparatus B 102, and the power supply apparatus C 103. The electronic apparatus 100 is not limited to the image capturing device, and may be a personal computer (a laptop PC or a tablet PC), a smartphone, or the like as long as it can receive power from a plurality of power supply apparatuses.

The power supply apparatus A 101, the power supply apparatus B 102, and the power supply apparatus C 103 may be mobile batteries connectable to the electronic apparatus 100. The power supply apparatus A 101, the power supply apparatus B 102, and the power supply apparatus C 103 are not limited to the mobile batteries, and may be chargers or the like using, as a power source, a commercial power source that can supply power to the power receiving apparatus.

The electronic apparatus 100, the power supply apparatus A 101, the power supply apparatus B 102, and the power supply apparatus C 103 include connectors conforming to the USB Type-C standard, and can be electrically connected by USB Type-C cables 104, 105, and 106.

In the present embodiment, the electronic apparatus 100, the power supply apparatus A 101, the power supply apparatus B 102, and the power supply apparatus C 103 operate as a power receiving apparatus (sink apparatus) and a power supply apparatus (source apparatus) conforming to the universal serial bus (USB) power delivery (PD) standard. The power receiving apparatus (sink apparatus) and the power supply apparatus (source apparatus) perform negotiation for deciding the supply power from a combination of a voltage value (e.g., 5 V, 9 V, 15 V, or 20 V) and a current value (e.g., 3 A or 5 A) decided in advance based on the power rule.

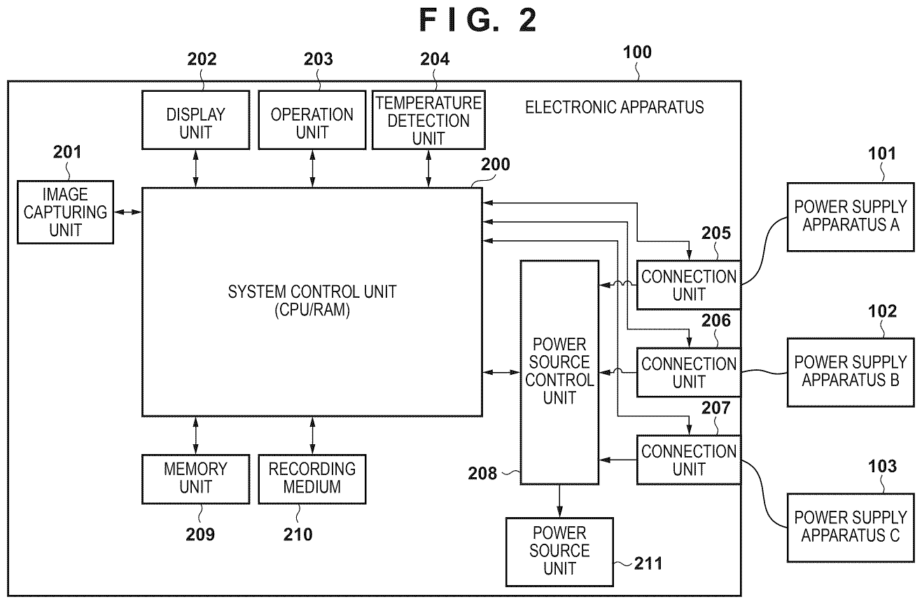

Next, the configuration and the function of the electronic apparatus according to the present embodiment will be described with reference to FIG. 2.

FIG. 2 is a block diagram illustrating the configuration of the electronic apparatus according to the present embodiment.

The electronic apparatus 100 includes a system control unit 200, an image capturing unit 201, a display unit 202, an operation unit 203, a temperature detection unit 204, connection units 205, 206, and 207, a power source control unit 208, a memory unit 209, a recording medium 210, and a power source unit 211.

The system control unit 200 includes a processor (CPU) that performs arithmetic processing and control processing of the electronic apparatus 100 and a work memory (RAM) to be loaded with constants and variables for operation of the system control unit 200, a control program read from the memory unit 209, and the like. The system control unit 200 controls each component of the electronic apparatus 100 by loading a control program stored in the memory unit 209 into the work memory and executing the program.

The image capturing unit 201 includes an image sensor including a charge coupled device (CCD), a complementary metal oxide semiconductor (CMOS) element, or the like, and converts an optical image of a subject into an electric signal.

The system control unit 200 performs various types of image processing on image data captured by the image capturing unit 201, generates an image file such as a still image or a moving image, and displays the image file on the display unit 202 or records the image file on the recording medium 210. The system control unit 200 performs predetermined arithmetic processing using the image data captured by the image capturing unit 201, and performs exposure control and distance measurement control based on the arithmetic result.

The display unit 202 performs display of a live view image, display of a captured image, character display for interactive operation, operation mode display of the electronic apparatus 100, and the like. The display unit 202 displays the operable time of the electronic apparatus 100 based on remaining battery level information attached to the electronic apparatus 100 and remaining battery level information of the power supply apparatus connected to the electronic apparatus 100. The display unit 202 is a display device such as, for example, a liquid crystal display or an organic EL display. The display unit 202 may have a configuration of being integrated with the electronic apparatus 100 or may be an external device connected to the electronic apparatus 100.

The operation unit 203 is an operation member such as various switches, a button, and a touchscreen that receive various operations from the user and notify the system control unit 200. The operation unit 203 provides a user interface for the user to operate the electronic apparatus 100.

The temperature detection unit 204 detects a temperature of a device (heat source device) serving as a heat source in each component of the electronic apparatus 100 and notifies the system control unit 200. The heat source device is the system control unit 200 and the image capturing unit 201 that generate heat by, for example, the electronic apparatus 100 operating in a power on state. The system control unit 200 executes control processing based on the temperature information of the heat source device detected by the temperature detection unit 204. For example, the system control unit 200 restricts or stops the operation of the electronic apparatus 100 so as not to exceed the operation guarantee temperature of the heat source device. The temperature detection unit 204 includes a temperature sensor such as a thermistor.

The connection units 205, 206, and 207 are power receiving units that connect the power supply apparatus A 101, the power supply apparatus B 102, and the power supply apparatus C 103 to the electronic apparatus 100 and receive power supply from the power supply apparatus A 101, the power supply apparatus B 102, and the power supply apparatus C 103. The power supply apparatus A 101, the power supply apparatus B 102, and the power supply apparatus C 103 are interfaces conforming to the USB PD standard, for example. The connection units 205, 206, and 207 are, for example, USB Type-C connectors to which the USB Type-C cables 104, 105, and 106 can be connected. The connection units 205, 206, and 207 can communicate data conforming to the USB PD standard and exchange power with the power supply apparatus A 101, the power supply apparatus B 102, and the power supply apparatus C 103 connected via the USB Type-C cables 104, 105, and 106. The connection units 205, 206, and 207 output, to the power source control unit 208, power (VBUS) supplied from the power supply apparatus A 101, the power supply apparatus B 102, and the power supply apparatus C 103.

Note that the connection units 205, 206, and 207 are not limited to interfaces conforming to the USB PD standard, and may be interfaces capable of communication and power reception by other methods.

The power source control unit 208 outputs, to the power source unit 211, the power (VBUS) received by the connection units 205, 206, and 207.

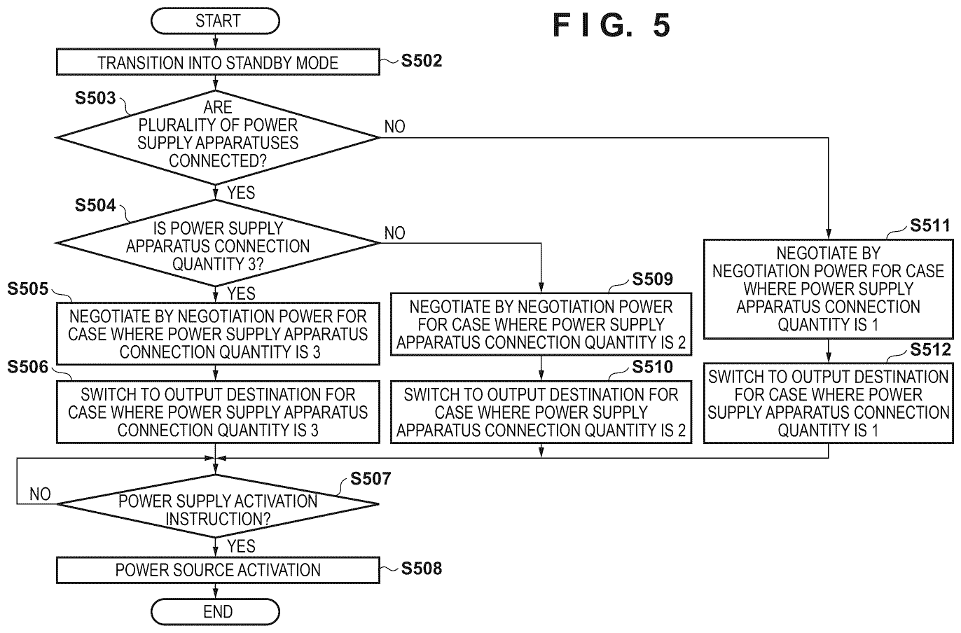

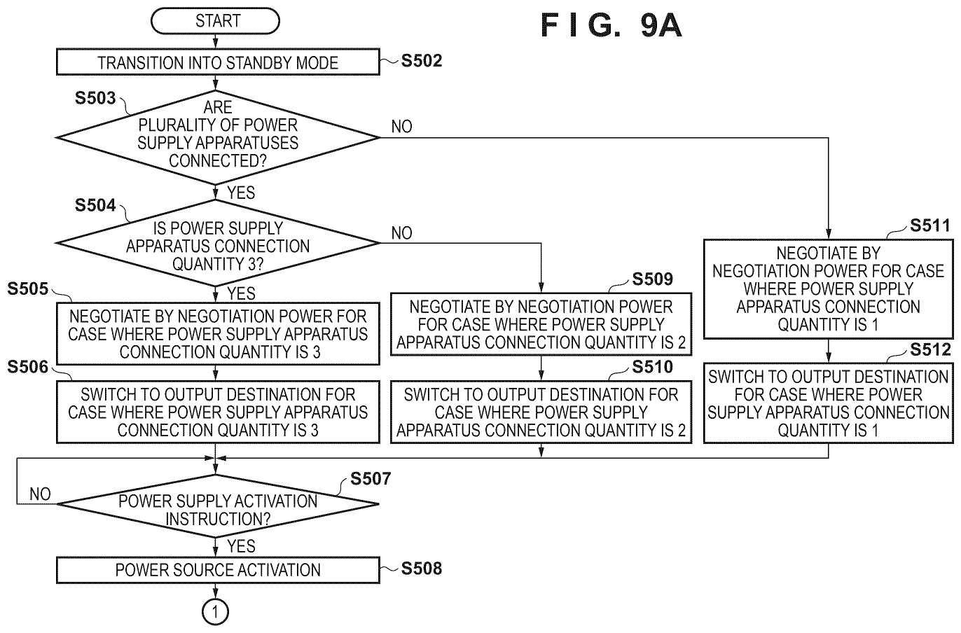

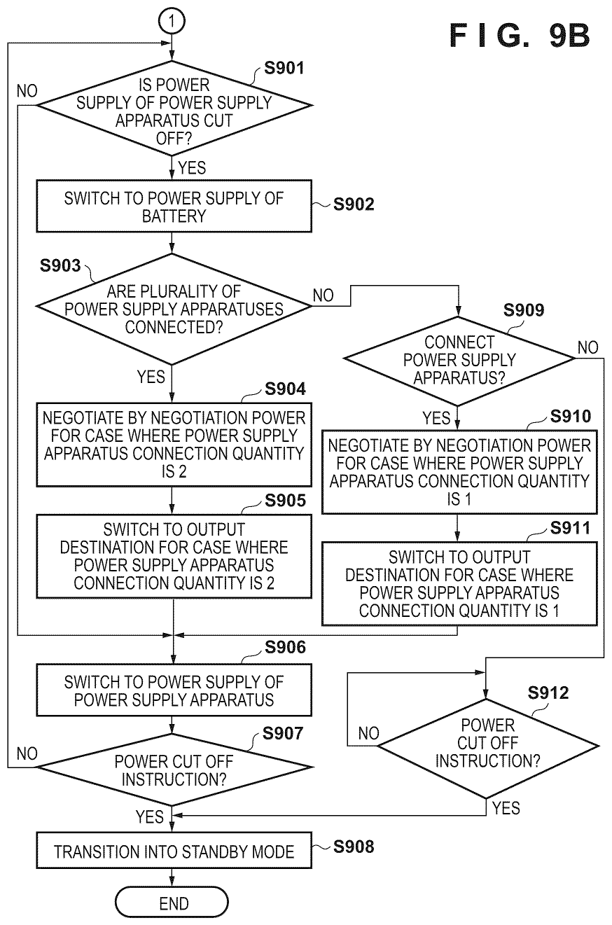

The memory unit 209 stores constants, programs, and the like for the operation of the system control unit 200. The program of the present embodiment is a program for executing the flowchart described below with reference to FIG. 5 and FIGS. 9A and 9B. Other than the program, the memory unit 209 stores, for example, reference data used for image processing, power consumption information for each operation mode, operation mode information, image data for notifying the user of the state of the electronic apparatus 100, and the like. The memory unit 209 is, for example, an EEPROM or a flash memory.

The recording medium 210 is a memory card, a hard disk, or the like capable of writing and reading data by the system control unit 200. The recording medium 210 saves an image file, a control program, and the like.

The power source unit 211 converts a voltage value of power output from the power source control unit 208 into a voltage value at which the load unit connected to the power source unit 211 can operate, and supplies power to the load unit. The power source unit 211 includes a plurality of power source circuits that supply power to a plurality of the load units of the electronic apparatus 100.

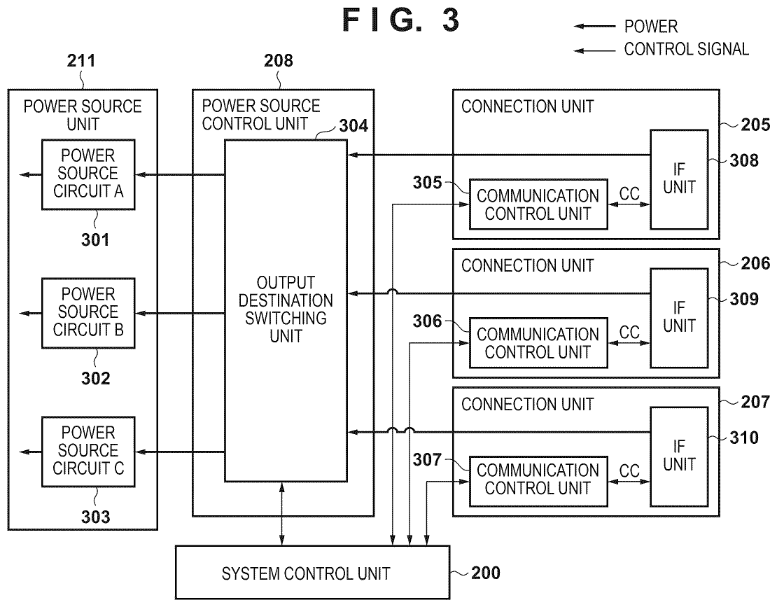

Next, the configurations and the functions of the connection units 205, 206, and 207, the power source control unit 208, and the power source unit 211 of the electronic apparatus 100 will be described with reference to FIG. 3.

The connection units 205, 206, and 207 have similar configurations and functions. The connection unit 205 includes an interface (IF) unit 308 and a communication control unit 305. The connection unit 206 includes an interface unit 309 and a communication control unit 306. The connection unit 207 includes an interface unit 310 and a communication control unit 307.

The power source control unit 208 includes an output destination switching unit 304. The power source unit 211 includes a power source circuit A301, a power source circuit B302, and a power source circuit C303.

The interface unit 308 is a connector conforming to the USB Type-C standard, and can be connected to the power supply apparatus A 101 via the USB Type-C cable 104. The interface unit 308 outputs, to the output destination switching unit 304, a VBUS voltage based on the power supplied from the power supply apparatus A 101.

The communication control unit 305 is connected to a CC terminal of the interface unit 308 and operates as a USB PD controller that performs communication conforming to the USB PD standard (hereinafter, CC communication) when the power supply apparatus A 101 is connected.

The communication control unit 305 performs CC communication with the power supply apparatus A 101 connected to the interface unit 308, detects connection of the power supply apparatus A 101, detects a combination of a voltage value and a current value that can be supplied by the power supply apparatus A 101 that is connected, and notifies the system control unit 200 of a detection result.

The communication control unit 305 performs negotiation for deciding the combination of the voltage value and the current value that is power supplied by the power supply apparatus A 101 by CC communication with the power supply apparatus A 101 and received by the electronic apparatus 100 and can be supplied by the power supply apparatus A 101.

The system control unit 200 notifies, via the communication control unit 305, the power supply apparatus A 101 of the combination of the voltage value and the current value requested to the power supply apparatus A 101, and decides the voltage value and the current value of the power supplied by the power supply apparatus A 101.

The communication control unit 305 controls the interface unit 308 to receive power supply from the power supply apparatus A 101 at a desired VBUS voltage based on the voltage value and the current value decided by the negotiation with the power supply apparatus A 101.

The interface unit 308 outputs, to the output destination switching unit 304, the VBUS voltage received from the power supply apparatus A 101.

Note that the interface units 309 and 310 of the connection units 206 and 207 have similar configurations and functions to those of the interface unit 308 of the connection unit 205. The communication control units 306 and 307 of the connection units 206 and 207 have similar configurations and functions to those of the communication control unit 305 of the connection unit 205.

The output destination switching unit 304 includes a plurality of switch circuits not illustrated. The output destination switching unit 304 outputs the power received by the connection units 205, 206, and 207 from the power supply apparatus A 101, the power supply apparatus B 102, and the power supply apparatus C 103 to any of the power source circuit A301, the power source circuit B302, and the power source circuit C303 of the power source unit 211. The output destination switching unit 304 inputs the VBUS voltage from the power supply apparatus A 101, the power supply apparatus B 102, and the power supply apparatus C 103 via the interface units 308, 309, and 310. The output destination switching unit 304 outputs the respective VBUS voltages input from the power supply apparatus A 101, the power supply apparatus B 102, and the power supply apparatus C 103 to any of the power source circuit A301, the power source circuit B302, and the power source circuit C303 of the power source unit 211.

The power source circuit A301, the power source circuit B302, and the power source circuit C303 receive any of the VBUS voltages input by the output destination switching unit 304 from the power supply apparatus A 101, the power supply apparatus B 102, and the power supply apparatus C 103.

The power source circuit A301 converts the voltage value of the VBUS voltage input from the output destination switching unit 304 and outputs the VBUS voltage to the load unit connected to the power source circuit A301. The power source circuit A301 converts the voltage value of the VBUS voltage input from the output destination switching unit 304 into a voltage value at which the load unit connected to the power source circuit A301 can operate, and outputs the VBUS voltage to the load unit.

The power source circuit B302 converts the voltage value of the VBUS voltage input from the output destination switching unit 304 and outputs the VBUS voltage to the load unit connected to the power source circuit B302. The power source circuit B302 converts the voltage value of the VBUS voltage input from the output destination switching unit 304 into a voltage value at which the load unit connected to the power source circuit B302 can operate, and outputs the VBUS voltage to the load unit.

The power source circuit C303 converts the voltage value of the VBUS voltage input from the output destination switching unit 304 and outputs the VBUS voltage to the load unit connected to the power source circuit C303. The power source circuit C303 converts the voltage value of the VBUS voltage input from the output destination switching unit 304 into a voltage value at which the load unit connected to the power source circuit C303 can operate, and outputs the VBUS voltage to the load unit.

The voltage values output from the power source circuit A301, the power source circuit B302, and the power source circuit C303 may be further converted by a power source circuit not illustrated and output as a power source of each load unit.

The system control unit 200 of the present embodiment may include two operation modes of a standby mode and a normal operation mode.

When the power supply apparatus A 101, the power supply apparatus B 102, and the power supply apparatus C 103 are connected to any of the interface units 308, 309, and 310, a VBUS voltage (5 V) is input to any of the interface units 308, 309, and 310. The VBUS voltage (5 V) input to any of the interface units 308, 309, and 310 is converted into a voltage value (e.g., 3.3 V) that enables the system control unit 200 to operate in the standby mode by a power source circuit not illustrated, and is output to the system control unit 200. Due to this, the system control unit 200 is activated in the standby mode.

The control of the communication control units 305, 306, and 307 and the output destination switching unit 304, and the detection of a user operation on the operation unit 203 can also be executed in the standby mode.

When the voltages output from the power source circuit A301, the power source circuit B302, and the power source circuit C303 are supplied to the components of the electronic apparatus 100, the system control unit 200 is switched to the normal operation mode.

In the present embodiment, an example has been described in which the system control unit 200 performs control of the communication control units 305, 306, and 307 and the output destination switching unit 304 and detection of the user operation on the operation unit 203. However, a separately provided control unit may be configured to perform control of the output destination switching and detection of the user operation.

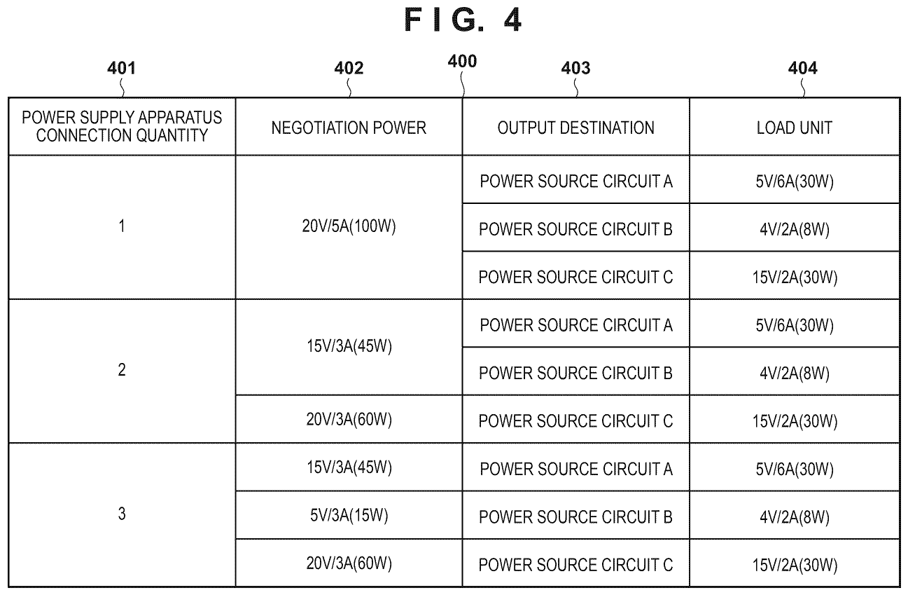

Next, the control processing that may be used for the present embodiment will be described with reference to FIGS. 4 and 5.

The system control unit 200 decides a voltage value and a current value at which power supply is received from the power supply apparatus connected to the electronic apparatus 100 based on the number of the power supply apparatuses connected to the electronic apparatus 100 and the power consumption of the load units connected to the power source circuit A301, the power source circuit B302, and the power source circuit C303. The system control unit 200 controls the power source control unit 208 so as to output the power received from the power supply apparatus connected to the electronic apparatus 100 to any of the power source circuit A301, the power source circuit B302, and the power source circuit C303 of the power source unit 211.

FIG. 4 illustrates a reference table 400 used for the control processing of the present embodiment.

A power supply apparatus connection quantity 401 indicates the number of the power supply apparatuses connected to the electronic apparatus 100 and corresponds to the connection quantity of the power supply apparatuses to any of the interface units 308, 309, and 310.

Negotiation power 402 indicates negotiation power supplied by each of the power supply apparatuses in accordance with the connection quantity of the power supply apparatuses. When the power supply apparatus connection quantity is 1, the negotiation power is 20 V/5 A (100 W). When the power supply apparatus connection quantity is 2, the negotiation power is 15 V/3 A (45 W) and 20 V/3 A (60 W). When the power supply apparatus connection quantity is 3, the negotiation power is 15 V/3 A (45 W), 5 V/3 A (15 W), and 20 V/3 A (60 W).

The system control unit 200 controls the communication control unit of the connection unit to which the power supply apparatus is connected so as to negotiate with the negotiation power 402 based on the power supply apparatus connection quantity 401 and the power consumption of a load unit 404.

An output destination 403 indicates an output destination of the power input from each power supply apparatus with the negotiation power 402, and includes at least any of the power source circuit A301, the power source circuit B302, and the power source circuit C303 as the output destination in the present embodiment.

The system control unit 200 controls the output destination switching unit 304 so that the output destination 403 of the negotiation power 402 received from the power supply apparatus A 101, the power supply apparatus B 102, and the power supply apparatus C 103 is any of the power source circuit A301, the power source circuit B302, and the power source circuit C303.

The load unit 404 indicates the power consumption of the load unit connected to the power source circuit A301, the power source circuit B302, and the power source circuit C303.

In the reference table 400, the negotiation power 402 and the output destination 403 are decided in advance such that the sum of power losses in the power source circuit A301, the power source circuit B302, and the power source circuit C303 is minimized with respect to the power consumption of the load unit 404.

Next, the control processing of the electronic apparatus 100 that may be used in accordance with the present embodiment will be described with reference to FIG. 5.

FIG. 5 is a flowchart exemplifying the control processing of the electronic apparatus 100 according to the present embodiment.

Note that the processing of FIG. 5 is implemented by the system control unit 200 loading a program stored in the memory unit 209 into the memory and executing the program to control each component of the electronic apparatus 100. The processing of FIG. 5 is started when the power supply apparatus A 101, the power supply apparatus B 102, and the power supply apparatus C 103 are connected to any of the interface units 308, 309, and 310. The same applies to FIGS. 9A and 9B described later in the below-discussed embodiment(s).

In step S502, the system control unit 200 is activated in the standby mode by the VBUS voltage (5 V) supplied from the interface unit to which the power supply apparatus is connected.

In step S503, the system control unit 200 determines whether or not a plurality of power supply apparatuses are connected to the electronic apparatus 100. The system control unit 200 determines whether or not at least two of the power supply apparatus A 101, the power supply apparatus B 102, and the power supply apparatus C 103 are connected to at least two of the interface units 308, 309, and 310. When the system control unit 200 determines that a plurality of power supply apparatuses are connected to the electronic apparatus 100, the system control unit 200 advances the processing to step S504. When the system control unit 200 determines that a plurality of power supply apparatuses are not connected to the electronic apparatus 100, the system control unit 200 advances the processing to step S511.

In step S511, based on the reference table 400, the system control unit 200 controls the communication control unit so as to negotiate with the power supply apparatus by the negotiation power for a case where the power supply apparatus connection quantity is 1.

In step S512, based on the reference table 400, the system control unit 200 controls the output destination switching unit 304 so as to set the output destination for the case where the power supply apparatus connection quantity is 1.

In step S504, the system control unit 200 determines whether or not the connection quantity of the power supply apparatuses is 3. The system control unit 200 advances the processing to step S505 when the connection quantity of the power supply apparatuses is 3, and advances the processing to step S509 when the connection quantity of the power supply apparatuses is not 3, that is, 2.

In step S509, based on the reference table 400, the system control unit 200 controls the communication control unit so as to negotiate with the power supply apparatus by the negotiation power for a case where the power supply apparatus connection quantity is 2.

In step S510, based on the reference table 400, the system control unit 200 controls the output destination switching unit 304 so as to set the output destination for the case where the power supply apparatus connection quantity is 2.

In step S505, based on the reference table 400, the system control unit 200 controls the communication control unit so as to negotiate with the power supply apparatus by the negotiation power for a case where the power supply apparatus connection quantity is 3.

In step S506, based on the reference table 400, the system control unit 200 controls the output destination switching unit 304 so as to set the output destination for the case where the power supply apparatus connection quantity is 3.

In step S507, the system control unit 200 stands by until the system control unit 200 receives a power activation instruction of the electronic apparatus 100 by a user operation via the operation unit 203, and upon determining that the power activation instruction has been received, the system control unit 200 advances the processing to step S508.

In step S508, the system control unit 200 activates the power source of each component of the electronic apparatus 100 and ends the processing.

According to the present embodiment, negotiation of the supply power of each power supply apparatus and control of the power source circuit of the power output destination of each power supply apparatus after the negotiation are performed based on the number of the power supply apparatuses connected to the electronic apparatus 100 and the power consumption of each load unit connected to the plurality of power source circuits. This can reduce a difference between the input voltage and the output voltage of the power source circuit of the power output destination of each power supply apparatus after the negotiation, and reduce the power loss due to the voltage conversion.

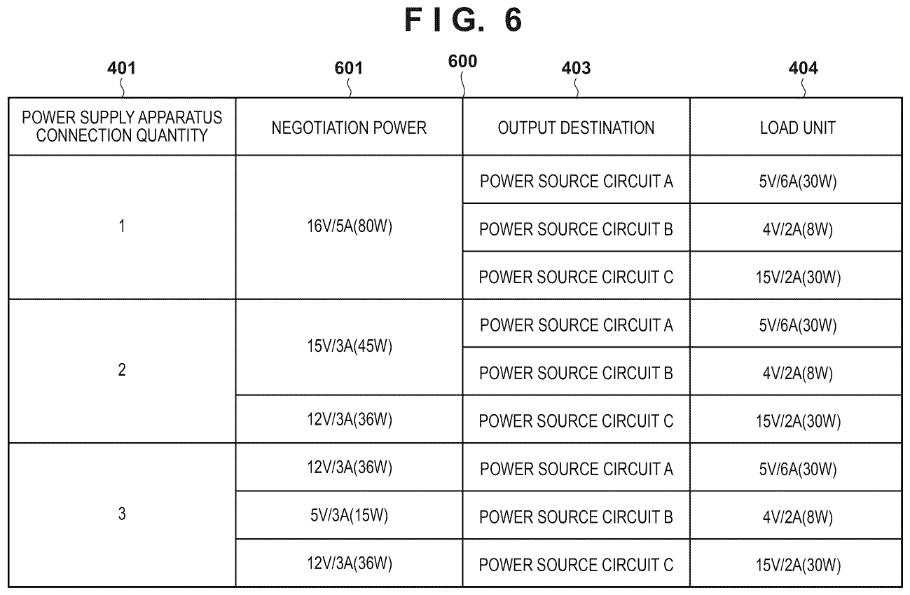

Next, one or more features of one or more additional embodiments will be described with reference to FIG. 6.

With the aforementioned embodiment, an example has been described in which negotiation of the supply power with the plurality of power supply apparatuses connected to the electronic apparatus 100 is selected from a combination (power data object (PDO)) of a voltage value and a current value decided in advance based on the power rule.

In contrast or in addition, a programmable power supply (PPS) function is added from the USB PD3.0 standard. In the PPS, the voltage value and the current value of the supply power can be set at intervals of 20 mV and 50 mA, and the voltage value and the current value can be changed at intervals smaller than intervals in the PDO.

The configuration and function of the electronic apparatus according to the present embodiment are similar to those of the aforementioned embodiment, and the reference table used for control by a system control unit 701 is different.

FIG. 6 illustrates a reference table 600 used for the control processing that may be used with the present, additional embodiment.

In FIG. 6, similar items to those in the aforementioned embodiment(s) are denoted by the same reference signs, and description thereof is omitted.

Negotiation power 601 indicates supply power that can be set by negotiation with the power supply apparatus by the PPS.

According to the present embodiment, by performing, by the PPS, negotiation of the supply power of the plurality of power supply apparatuses connected to the electronic apparatus 100, it is possible to further reduce a difference between the input voltage and the output voltage of the power source circuit of the power output destination of each power supply apparatus after the negotiation, and reduce the power loss due to the voltage conversion.

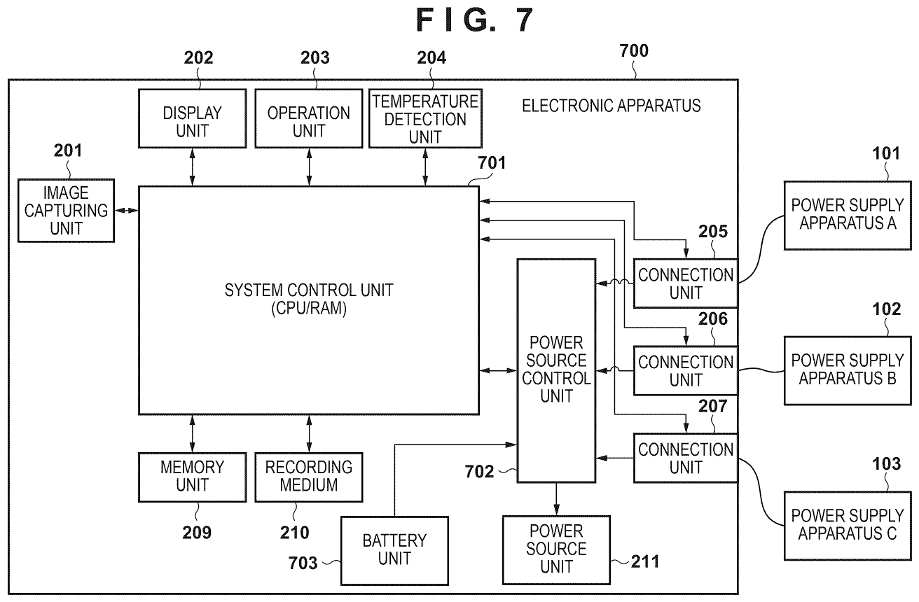

Next, a further embodiment will be described with reference to FIGS. 7 to 9B.

In the aforementioned embodiments, when a power supply to any of the plurality of power supply apparatuses connected to the electronic apparatus 100 is cut off due to a reason such as removal of a cable from a connector during power supply by the power supply apparatuses, power supply to a power source circuit from which power of the cut off power supply apparatus is output is also cut off. Therefore, the power supply to the load unit of the electronic apparatus 100 is stopped, and the operation of the electronic apparatus 100 is stopped.

In the present, further embodiment, when power supply to any of the plurality of power supply apparatuses connected to an electronic apparatus 700 is cut off during power supply by the power supply apparatuses, the power supply is switched to power supply by a battery unit 703 other than the power supply apparatus mounted to the electronic apparatus 700, and cut off of the power supply to the power source circuit is prevented. Furthermore, based on the number of power supply apparatuses during power supply and the power consumption of the load unit of the electronic apparatus 700, negotiation of the supply power of each power supply apparatus and the power source circuit of the power output destination of each power supply apparatus after the negotiation are controlled.

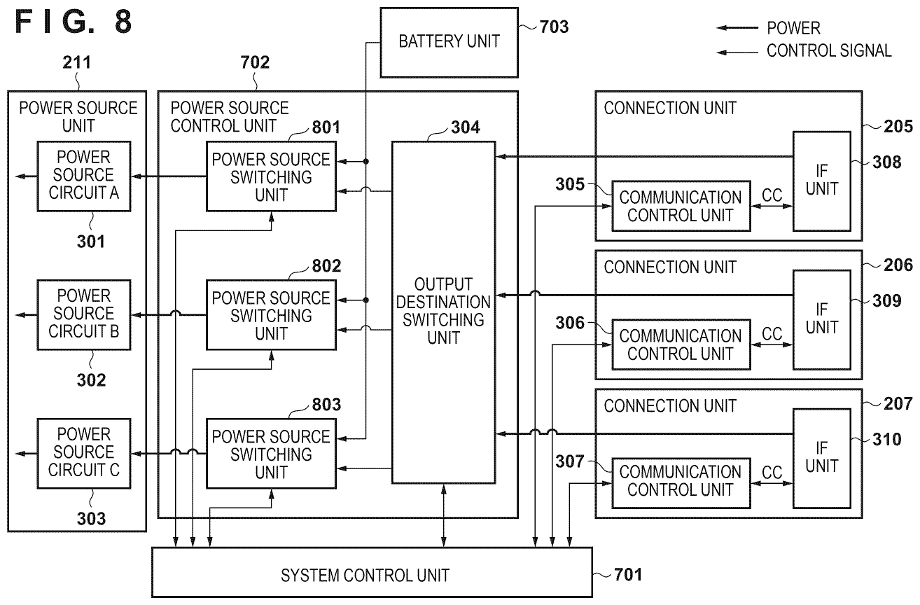

First, the configuration of the electronic apparatus 700 according to the present, further embodiment will be described with reference to FIGS. 7 and 8.

Similar configurations to those of the aforementioned embodiments are denoted by the same reference signs, and description thereof is omitted.

FIG. 7 is a block diagram illustrating the configuration of the electronic apparatus 700 according to the present, further embodiment.

The battery unit 703 is a secondary battery attachable to and detachable from the electronic apparatus 700, and is, for example, a lithium ion battery that can supply power with which the electronic apparatus 700 can operate.

Next, the control processing that may be used in accordance with the present, further embodiment will be described with reference to FIG. 8.

Next, the configurations and the functions of the connection units 205, 206, and 207, a power source control unit 702, and the power source unit 211 of the electronic apparatus 700 will be described with reference to FIG. 8.

The power source control unit 702 includes the output destination switching unit 304 and power source switching units 801, 802, and 803.

Under the control of the system control unit 701, the power source switching unit 801 switches the power to be output from the power source control unit 702 to the power source circuit A301 to any of the power received from the power supply apparatus A 101, the power supply apparatus B 102, and the power supply apparatus C 103 and the power of the battery unit 703.

The power source switching unit 801 includes a detection unit not illustrated that detects the output voltage of the output destination switching unit 304, and outputs the battery voltage of the battery unit 703 to the power source circuit A301 when the output voltage of the output destination switching unit 304 decreases to equal to or less than a threshold. The power source switching unit 801 notifies the system control unit 701 that the output voltage of the output destination switching unit 304 decreases to equal to or less than the threshold and the battery voltage is output to the power source circuit A301. The threshold used for voltage detection by the power source switching unit 801 is set by the system control unit 701.

The system control unit 701 determines a voltage value to be output from the output destination switching unit 304 to the power source circuit A301 from the negotiation power 402 and the output destination 403 of the reference table 400 illustrated in FIG. 4, and sets minus 10% of the determined voltage value as a threshold. Note that the setting method of the threshold is not limited to this, and may be set to an any value.

The configuration and function of the power source switching unit 802 are similar to those of the power source switching unit 801, and outputs the battery voltage of the battery unit 703 to the power source circuit B302 when the output voltage of the output destination switching unit 304 decreases to equal to or less than the threshold. The configuration and function of the power source switching unit 803 are similar to those of the power source switching unit 801, and outputs the battery voltage of the battery unit 703 to the power source circuit C303 when the output voltage of the output destination switching unit 304 decreases to equal to or less than the threshold.

Upon receiving the notification that the output voltage of the output destination switching unit 304 decreases to equal to or less than the threshold and the battery voltage is output from any of the power source switching units 801, 802, and 803 to the power source circuit A301, the power source circuit B302, and the power source circuit C303, the system control unit 701 performs control so as to output the battery voltage to the power source circuit also from another power source switching unit.

Next, the control processing of the electronic apparatus 700 according to the present embodiment will be described with reference to FIGS. 9A and 9B.

In FIGS. 9A and 9B, similar processing to the processing in FIG. 5 is denoted by the identical step number, and the description thereof is omitted.

After activating the power source of the electronic apparatus 700 in step S508, the system control unit 701 advances the processing to step S901.

In step S901, the system control unit 701 determines whether or not power supply by any of the power supply apparatuses is cut off. The system control unit 701 advances the processing to step S902 when the system control unit 701 determines that the power supply by any of the power supply apparatuses is cut off, and advances the processing to step S906 when the system control unit 701 determines that the power supply by any of the power supply apparatuses is not cut off.

In step S902, the system control unit 701 controls the power source control unit 702 so as to output the battery voltage to the power source unit 211.

In step S903, the system control unit 701 determines whether or not a plurality of power supply apparatuses are connected to the electronic apparatus 100. When the system control unit 701 determines that a plurality of power supply apparatuses are connected to the electronic apparatus 100, the system control unit 701 advances the processing to step S904. When the system control unit 701 determines that a plurality of power supply apparatuses are not connected to the electronic apparatus 100, the system control unit 701 advances the processing to step S909.

In step S904, based on the reference table 400 illustrated in FIG. 4, the system control unit 701 controls the communication control unit so as to negotiate with the power supply apparatus by the negotiation power for a case where the power supply apparatus connection quantity is 2.

In step S905, the system control unit 701 controls the output destination switching unit 304 so as to set the output destination for a case where the power supply apparatus connection quantity is 2 based on the reference table 400 illustrated in FIG. 4, and advances the processing to step S906.

In step S909, the system control unit 701 determines whether or not the power supply apparatus is connected. The system control unit 701 advances the processing to step S910 when the system control unit 701 determines that the power supply apparatus is connected, and advances the processing to step S912 when the system control unit 701 determines that the power supply apparatus is not connected.

In step S910, based on the reference table 400 illustrated in FIG. 4, the system control unit 701 controls the communication control unit so as to negotiate with the power supply apparatus by the negotiation power for a case where the power supply apparatus connection quantity is 1.

In step S911, the system control unit 701 controls the output destination switching unit 304 so as to set the output destination for a case where the power supply apparatus connection quantity is 1 based on the reference table 400 illustrated in FIG. 4, and advances the processing to step S906.

In step S912, the system control unit 701 stands by until the system control unit 701 receives a power cut off instruction of the electronic apparatus 100 by a user operation via the operation unit 203, and upon determining that the power cut off instruction has been received, the system control unit 701 advances the processing to step S908.

In step S906, the system control unit 701 controls the power source control unit 702 so as to output the VBUS voltage of the power supply apparatus to the power source unit 211.

In step S9907, the system control unit 701 determines whether or not the power cut off instruction of the electronic apparatus 100 has been received by the user operation via the operation unit 203. The system control unit 701 advances the processing to step S908 when the system control unit 701 determines that the power cut off instruction has been received, and returns the processing to step S901 when the system control unit 701 determines that the power cut off instruction has not been received.

In step S908, the system control unit 701 cuts off the power source of each component of the electronic apparatus 100, transitions to the standby mode, and ends the processing.

In the present embodiment, the reference table 400 illustrated in FIG. 4 is used in the processing of steps S905, S906, S910, and S911, but the reference table 600 of FIG. 6 according to, and discussed being used with, the aforementioned embodiment may be used with the present, further embodiment.

According to the present, further embodiment, when power supply to any of the plurality of power supply apparatuses connected to the electronic apparatus 100 is cut off during power supply by the power supply apparatuses, the power supply can be switched to power supply by a battery unit 703 other than the power supply apparatus mounted to the electronic apparatus 100, and cut off of the power supply to the power source circuit can be prevented. Furthermore, based on the number of power supply apparatuses during power supply and the power consumption of the load unit of the electronic apparatus, negotiation of the supply power of each power supply apparatus and the power source circuit of the power output destination of each power supply apparatus after the negotiation are controlled. This can reduce a difference between the input voltage and the output voltage of the power source circuit of the power output destination of each power supply apparatus after the negotiation, and reduce the power loss due to the voltage conversion.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to one or more embodiments, it is to be understood that the technical scope of the present disclosure is not limited to the disclosed one or more embodiments. The scope of the following claims is to be accorded the broadest interpretation so as to encompass all such modifications, equivalent structures, and functions.

What is claimed is:

1. An electronic apparatus comprising:
a connection unit to which a plurality of power supply apparatuses can be connected;
a plurality of power receiving units that receive a power from the plurality of power supply apparatuses;
a plurality of power source units that convert voltage values of power supplied from the plurality of power supply apparatuses and supply the power to a plurality of load units; and
a control unit that decides a voltage value and a current value for receiving the power from the plurality of power supply apparatuses based on a number of the plurality of power supply apparatuses and a power consumption of the plurality of load units, and that performs control to output the power received from the plurality of power supply apparatuses to any of the plurality of power source units.

2. The apparatus according to claim 1, wherein
the control unit communicates with the plurality of power supply apparatuses, and the control unit decides a combination of a predetermined voltage value and a current value from a plurality of combinations of voltage values and current values that can be supplied by the plurality of power supply apparatuses based on the number of the power supply apparatuses and the power consumption of the plurality of load units.

3. The apparatus according to claim 2, wherein
the control unit decides a first combination of a voltage value and a current value for receiving the power from the plurality of power supply apparatuses and an output destination of the power received from the plurality of power supply apparatuses such that a sum of power losses in the plurality of power source units is minimized with respect to the power consumption of the plurality of load units.

4. The apparatus according to claim 3, wherein
the control unit decides a second combination of a voltage value and a current value supplied from the plurality of power supply apparatuses and an output destination of the power received from the plurality of power supply apparatuses such that a sum of power losses in the plurality of power source units is minimized with respect to the power consumption of the plurality of load units, and in the second combination, the voltage value and the current value for receiving the power from the plurality of power supply apparatuses can be changed at intervals smaller than intervals in the first combination.

5. The apparatus according to claim 1, further comprising:
a switching unit that outputs, to any of the plurality of power source units, the power received by the plurality of power receiving units from the plurality of power supply apparatuses,
wherein the control unit controls the switching unit to switch an output destination of the power received from the plurality of power supply apparatuses to any of the plurality of power source units.

6. The apparatus according to claim 1, further comprising:
a battery unit,
wherein the control unit switches the power to be output to the plurality of power source units to any of the following: the power received from the plurality of power supply apparatuses and a power of the battery unit.

7. The apparatus according to claim 6, wherein
the control unit switches the power to be output to the plurality of power source units to the power of the battery unit in a case where the power received from or supplied by any of the plurality of power supply apparatuses is cut off.

8. The apparatus according to claim 7, further comprising:
a switching unit that outputs, to any of the plurality of power source units, the power received by the plurality of power receiving units from the plurality of power supply apparatuses,
wherein the switching unit notifies the control unit that the power received from or supplied by any of the plurality of power supply apparatuses is cut off, and
upon receiving the notification, the control unit switches power to be output to all of the plurality of power source units to the power of the battery unit.

9. The apparatus according to claim 7, wherein
the control unit decides a combination of a voltage value and a current value for receiving the power from the plurality of power supply apparatuses and an output destination of the power received from the plurality of power supply apparatuses, and switches the power to be output to the plurality of power source units to the power received from the plurality of power supply apparatuses.

10. The apparatus according to claim 1, wherein
the connection unit is an interface conforming to a USB Type-C standard, and
the electronic apparatus and the power supply apparatus are apparatuses conforming to a universal serial bus (USB) power delivery (PD) standard.

11. A control method of an electronic apparatus including a connection unit to which a plurality of power supply apparatuses can be connected, a plurality of power receiving units that receive a power from the plurality of power supply apparatuses, and a plurality of power source units that convert voltage values of power supplied from the plurality of power supply apparatuses and supply the power to a plurality of load units, the control method comprising:
deciding a voltage value and a current value for receiving the power from the plurality of power supply apparatuses based on a number of the plurality of power supply apparatuses and a power consumption of the plurality of load units, and
performing control to output the power received from the plurality of power supply apparatuses to any of the plurality of power source units.

12. The method according to claim 11, wherein
the performing control step further includes: communicating with the plurality of power supply apparatuses, and deciding a combination of a predetermined voltage value and a current value from a plurality of combinations of voltage values and current values that can be supplied by the plurality of power supply apparatuses based on the number of the power supply apparatuses and the power consumption of the plurality of load units.

13. The method according to claim 12, wherein
the performing control step further includes: deciding a first combination of a voltage value and a current value for receiving the power from the plurality of power supply apparatuses and an output destination of the power received from the plurality of power supply apparatuses such that a sum of power losses in the plurality of power source units is minimized with respect to the power consumption of the plurality of load units.

14. The method according to claim 13, wherein
the performing control step further includes: deciding a second combination of a voltage value and a current value supplied from the plurality of power supply apparatuses and an output destination of the power received from the plurality of power supply apparatuses such that a sum of power losses in the plurality of power source units is minimized with respect to the power consumption of the plurality of load units, and in the second combination, the voltage value and the current value for receiving the power from the plurality of power supply apparatuses can be changed at intervals smaller than intervals in the first combination.

15. The method according to claim 11, wherein the electronic apparatus further comprises a switching unit that outputs, to any of the plurality of power source units, the power received by the plurality of power receiving units from the plurality of power supply apparatuses,
wherein the performing control step further includes: controlling the switching unit to switch an output destination of the power received from the plurality of power supply apparatuses to any of the plurality of power source units.

16. The method according to claim 11, wherein the electronic apparatus further comprises a battery unit,
wherein the performing control step further includes: switching the power to be output to the plurality of power source units to any of the following: the power received from the plurality of power supply apparatuses and a power of the battery unit.

17. The method according to claim 16, wherein
the performing control step further includes: switching the power to be output to the plurality of power source units to the power of the battery unit in a case where the power received from or supplied by any of the plurality of power supply apparatuses is cut off.

18. The method according to claim 17, wherein the electronic apparatus further comprises a switching unit that outputs, to any of the plurality of power source units, the power received by the plurality of power receiving units from the plurality of power supply apparatuses,
wherein the switching unit notifies the control unit that the power received from or supplied by any of the plurality of power supply apparatuses is cut off, and
the performing control step further includes: upon receiving the notification, switching power to be output to all of the plurality of power source units to the power of the battery unit.

19. The method according to claim 17, wherein
the performing control step further includes: deciding a combination of a voltage value and a current value for receiving the power from the plurality of power supply apparatuses and an output destination of the power received from the plurality of power supply apparatuses, and switching the power to be output to the plurality of power source units to the power received from the plurality of power supply apparatuses.

20. The method according to claim 11, wherein
the connection unit is an interface conforming to a USB Type-C standard, and
the electronic apparatus and the power supply apparatus are apparatuses conforming to a universal serial bus (USB) power delivery (PD) standard.

21. A non-transitory computer-readable storage medium storing a program for causing a computer to perform a control method of an electronic apparatus including a connection unit to which a plurality of power supply apparatuses can be connected, a plurality of power receiving units that receive a power from the plurality of power supply apparatuses, and a plurality of power source units that convert voltage values of power supplied from the plurality of power supply apparatuses and supply the power to a plurality of load units, the control method comprising:
deciding a voltage value and a current value for receiving the power from the plurality of power supply apparatuses based on a number of the plurality of power supply apparatuses and a power consumption of the plurality of load units, and
performing control to output the power received from the plurality of power supply apparatuses to any of the plurality of power source units.
